(19) United States
(12) Patent Application Publication
(10) Pub. No.: US 2015/0066707 A1
(43) Pub. Date: Mar. 5, 2015

(54) Methods and Systems for Personalizing an In-Store Shopping Experience for a User in a Retail Store that Provides Accessories for Computing Devices

(71) Applicant: Cellco Partnership d/b/a Verizon Wireless, Basking Ridge, NJ (US)

(72) Inventors: Joseph Unger, Bernardsville, NJ (US); Gunnar Kiene, New York, NY (US); Kieron Leppard, Brooklyn, NY (US)

(73) Assignee: Cellco Partnership d/b/a Verizon Wireless, Basking Ridge, NJ (US)

(21) Appl. No.: 14/016,822

(22) Filed: Sep. 3, 2013

(51) Int. Cl. G06Q 30/06

(52) U.S. Cl. CPC G06Q 30/0641
USPC 705/27.1

(57) ABSTRACT

An exemplary method includes a shopping personalization system 1) detecting that a user is located within a geographic vicinity of a retail store that provides accessories for computing devices, 2) accessing, in response to the detecting that the user is located within the geographic vicinity of the retail store, a user profile associated with the user, 3) identifying a computing device associated with the user, and 4) providing a personalized in-store shopping experience for the user in accordance with the user profile and the identified computing device while the user is located within the geographic vicinity of the retail store. Corresponding methods and systems are also disclosed.

### BACKGROUND INFORMATION

Retail stores that provide (e.g., sell) accessories for computing devices (e.g., mobile phones, tablet computers, laptop computers, personal computers, etc.) are commonplace. For example, many wireless network service providers (e.g., VERIZON WIRELESS, T-MOBILE, AT&T, etc.) have stores in malls and other shopping areas where they not only sell wireless network service plans and devices, but accessories that go with those devices. Such accessories include carrying cases, charging devices, Bluetooth headsets, input devices, and many others.

It is often challenging for a person shopping at a retail store that provides accessories for computing devices to locate accessories that are compatible with his or her particular computing device. For example, a shopper may desire to purchase a carrying case for his or her tablet computer, but may not be able to readily ascertain which carrying cases available for sale in the retail store are compatible with the tablet computer (e.g., which carrying cases fit the tablet computer). This may especially be the case if the shopper does not have the tablet computer with him or her while in the retail store or know the specific make and model of the tablet computer. As a result, the shopper may either refrain from purchasing a carrying case or inadvertently purchase a carrying case that is not compatible with the tablet computer.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary shopping personalization system according to principles described herein.

FIGS. 2-3 show an exemplary geographic vicinity associated with a retail store according to principles described herein.

FIGS. 4-13 show various interfaces that may be presented in accordance with the methods and systems described herein.

FIGS. 14-15 show exemplary geographic vicinities of displays located within a retail store according to principles described herein.

FIG. 16 illustrates an exemplary implementation of the system of FIG. 1 according to principles described herein.

FIG. 17 illustrates an exemplary method of personalizing an in-store shopping experience for a user in a retail store according to principles described herein.

FIG. 18 illustrates another exemplary method of personalizing an in-store shopping experience for a user in a retail store according to principles described herein.

FIG. 19 illustrates another exemplary method of personalizing an in-store shopping experience for a user in a retail store according to principles described herein.

FIG. 20 illustrates another exemplary method of personalizing an in-store shopping experience for a user in a retail store according to principles described herein.

FIG. 21 illustrates an exemplary computing device according to principles described herein.

### DETAILED DESCRIPTION OF PREFERRED EMBODIMENTS

Methods and systems for personalizing an in-store shopping experience for a user (e.g., a shopper) in a retail store that provides accessories for computing devices are described herein. As will be described below, a shopping personalization system (e.g., a computer-implemented shopping personalization system) may 1) detect that a user is located within a geographic vicinity of a retail store that provides accessories for computing devices, 2) access, in response to the detecting that the user is located within the geographic vicinity of the retail store, a user profile associated with the user, 3) identify a computing device associated with the user, and 4) provide a personalized in-store shopping experience for the user in accordance with the user profile and the identified computing device while the user is located within the geographic vicinity of the retail store.

To illustrate, a user may enter a retail store associated with (e.g., owned by or contracted with) a wireless network service provider. The shopping personalization system may detect that the user is located within the retail store (e.g., by detecting an establishment of a communication link, such as a near field communication link, between a mobile device carried by the user and a computing device associated with and located within the retail store, using a global positioning system (“OPS”) service to determine that a mobile device carried by the user is located within the retail store, etc.). In response to detecting that the user is located within the retail store, the shopping personalization system may access a user profile associated with the user (e.g., a user profile or account associated with an online service provided by the wireless network service provider) and determine that the user has three different mobile devices linked to his or her user profile. The shopping personalization system may then present an interface to the user that allows the user to select one of the mobile devices as the mobile device for which he or she is shopping for accessories. The shopping personalization system may then provide a personalized in-store shopping experience for the user in accordance with the user profile and the selected mobile device. For example, the shopping personalization system may identify one or more accessories available in the retail store that are compatible with the selected mobile device and present interactive content associated with the identified one or more accessories by way of a display (e.g., a touch screen) associated with and located within the retail store. Other manners in which the in-store shopping experience of the user may be personalized will be described below.

The methods and systems described herein may allow a user (e.g., a shopper) to have a more productive and enjoyable shopping experience while shopping at a retail store. For example, the methods and systems described herein may allow a user to easily ascertain which accessories available in the retail store are compatible with the particular types of computing devices used by the user, identify accessories that are currently trending in popularity, and seamlessly blend his or her in-store shopping experience with his or her online shopping experience.

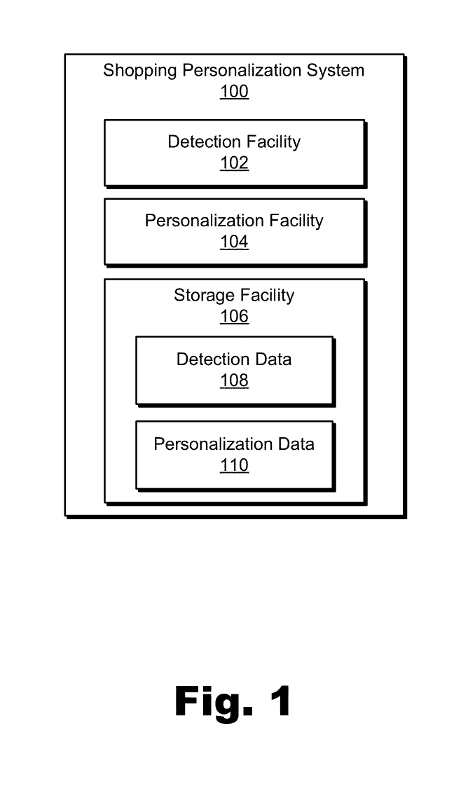

FIG. 1 illustrates an exemplary shopping personalization system 100 (“system 100”). As shown, system 100 may include, without limitation, a detection facility 102, a personalization facility 104, and a storage facility 106 selectively and communicatively coupled to one another. Storage facility 106 may be configured to maintain detection data 108 generated and/or used by detection facility 102 and personalization data 110 generated and/or used by personalization facility 104. Storage facility 106 may maintain additional or alternative data as may serve a particular implementation. It will be recognized that although facilities 102-106 are shown to be separate facilities in FIG. 1, any of facilities 102-106 may be combined into fewer facilities, such as into a single facility, or divided into more facilities as may serve a particular implementation.

Detection facility 102 may be configured to detect that a user is located within a geographic vicinity of a retail store that provides accessories for computing devices. This may be performed in any suitable manner. For example, detection facility 102 may detect that a user is located within the geographic vicinity of the retail store by detecting a geographic location of a mobile device associated with (e.g., carried by) the user and determining that the detected geographic location is within the geographic vicinity of the retail store.

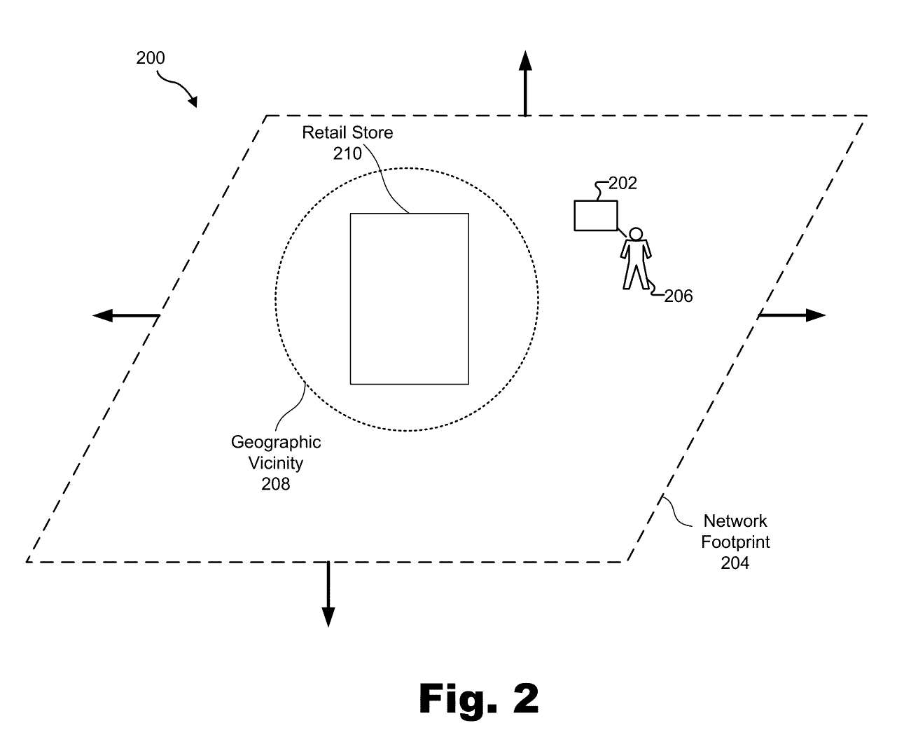

To illustrate, FIG. 2 shows a configuration 200 wherein a mobile device 202 is physically located at a particular geographic location within an exemplary network footprint 204. Network footprint 204 refers to a collective geographic space within which mobile device 202 is able to receive and transmit network communication signals (e.g., signals to or from a satellite or a broadcast tower). As represented by arrows in FIG. 2, the reach of the network footprint 204 may extend beyond the illustrated portion of the network footprint 204. Additionally, while FIG. 2 illustrates a two-dimensional network footprint 204, it will be understood that the network footprint 204 may be three dimensional in certain implementations.

Mobile device 202 may include a mobile phone, a smartphone, a tablet computer, a laptop computer, and/or any other mobile computing device as may serve a particular implementation. As shown, mobile device 202 may be associated with (e.g., carried and/or used by) a user 206.

FIG. 2 also illustrates an exemplary geographic vicinity 208 of a retail store 210 that has a physical presence within network footprint 204. As used herein, a “retail store” refers to any building, space within a building, kiosk, and/or any other type of physical structure within network footprint 204 that provides (e.g., sells and/or rents) accessories for computing devices.

The boundaries of geographic vicinity 208 may be user-definable and may include any suitable area as may serve a particular application. For example, as shown in FIG. 2, geographic vicinity 208 may include a circle having a radius that is a predetermined distance from a center of retail store 210. Alternatively, the boundaries of geographic vicinity 208 may be defined by the physical boundaries of retail store 210 (i.e., anything within retail store 210 is included within geographic vicinity 208). Other boundaries for geographic vicinity 208 may be defined as may serve a particular application.

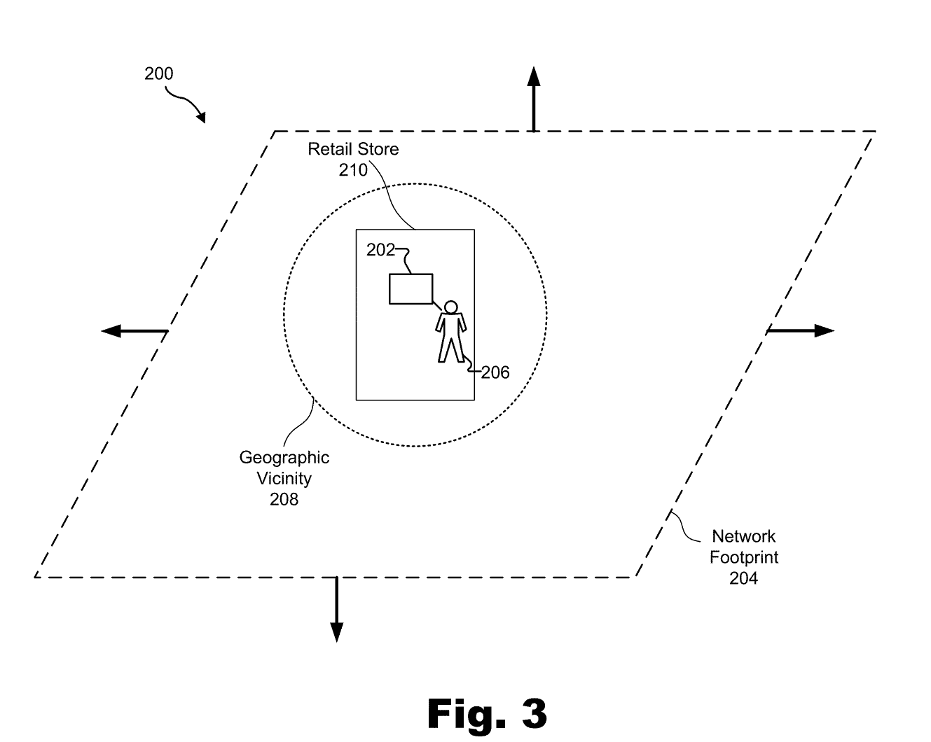

As shown, mobile device 202 and user 206 are initially located outside the boundaries of geographic vicinity 208. User 206 may then walk or otherwise enter into geographic vicinity 208, as illustrated in FIG. 3. In response, detection facility 102 may detect that the user has entered geographic vicinity 208 (e.g., by detecting a geographic location of mobile device 202 using GPS or any other suitable location tracking service and determining that the detected geographic location is within geographic vicinity 208).

Additionally or alternatively, detection facility 102 may detect that the user is located within the geographic vicinity of the retail store by detecting, while the user is located within the geographic vicinity of the retail store, an establishment of a communication link between a mobile device carried by the user and a computing device located within the geographic vicinity of the retail store. For example, the retail store may place a computing device that includes a near field communication (“NFC”) reader next to an entrance of the retail store. Upon entering the retail store, a user may place his or her mobile device in close proximity with the NFC reader (e.g., by touching the NFC reader with the mobile device) to establish an NFC link between the mobile device and the computing device that includes the NFC reader. Detection facility 102 may detect the establishment of the NFC link and accordingly determine that the user associated with the mobile device is located within the geographic facility of the retail store. It will be recognized that the computing device that includes the NFC reader may additionally or alternatively be placed near a display case that houses accessories and/or at any other location within the retail store as may serve a particular implementation. It will be also recognized that any other type of communication link (e.g., Bluetooth, Wi-Fi, etc.) may be established between the mobile device and the computing device located within the geographic vicinity of the retail store and may indicate that the user is located within the geographic vicinity of the retail store.

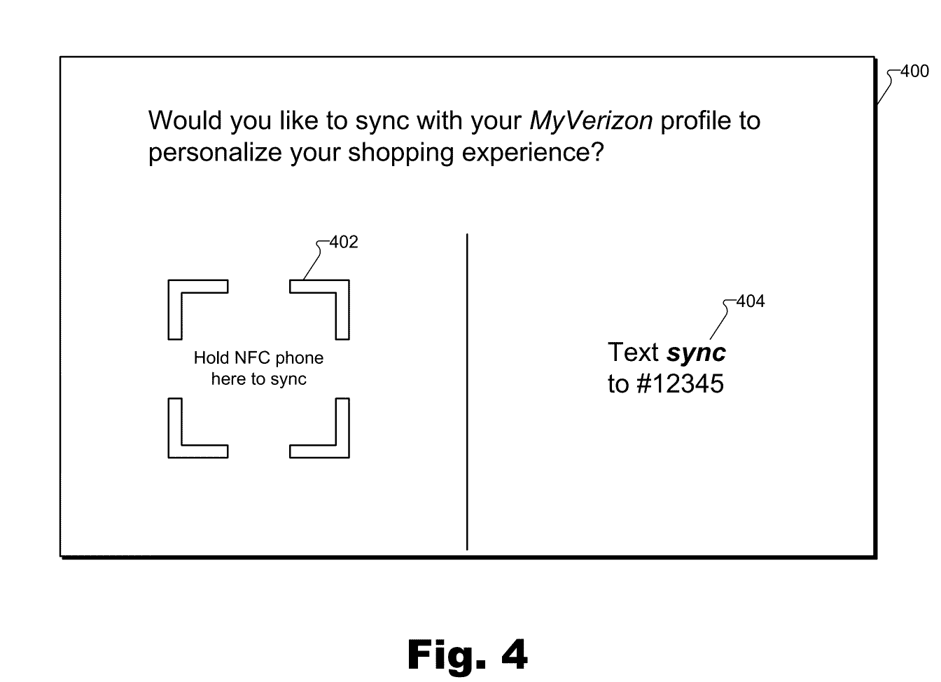

FIG. 4 shows an exemplary interface 400 that may be presented by way of a display located within the geographic vicinity of a retail store and that may be used to facilitate establishment of an NFC link between a user's mobile device and an NFC reader associated with the display. As used herein, a “display” refers to a physical display, such as a display screen associated with a computing device, a television display, and/or any other physical display as may serve a particular implementation. The display may be located at an entrance of the retail store, within a particular section of the retail store (e.g., next to a display case that houses accessories), and/or at any other location within the geographic vicinity of the retail store as may serve a particular implementation.

As shown, interface 400 may include a graphical representation 402 of an NFC target. In some examples, the user may hold his or her mobile device (e.g., an NFC-enabled mobile phone) up to graphical representation 402 in order to establish an NFC link between the mobile device and the NFC reader.

Additionally or alternatively, detection facility 102 may detect that the user is located within the geographic vicinity of the retail store by detecting input provided by the user. For example, a user may send an electronic message (e.g., a text message or an email) with his or her mobile device to an online service associated with the retail store in order to indicate that the user is located within the geographic vicinity of the retail store. To illustrate, FIG. 4 shows that a notification 404 may be displayed within interface 400 and notify the user that he or she may send a text message to a particular text message destination (e.g., a phone number) in order to notify detection facility 102 that he or she is located within the geographic vicinity of the retail store. Additionally or alternatively, the user may provide a username and/or password (e.g., a username and/or password associated with an online service associated with the retail store) by way of an interface (e.g., interface 400) presented by way of a display located within the geographic vicinity of the retail store in order to notify detection facility 102 that he or she is located within the geographic vicinity of the retail store. Detection facility 102 may detect any of these types of user input and accordingly determine that the user is located within the geographic vicinity of the retail store.

Returning to FIG. 1, personalization facility 104 may be configured to perform one or more shopping personalization operations as may serve a particular implementation. For example, in response to detection facility 102 detecting that a user is located within a geographic vicinity of a retail store, personalization facility 104 may access a user profile associated with the user, identify a computing device associated with the user, and provide a personalized in-store shopping experience for the user in accordance with the user profile and the identified computing device while the user is located within the geographic vicinity of the retail store. Each of these actions will be described in more detail below.

Personalization facility 104 may access a user profile associated with the user in any suitable manner. For example, the user profile may be maintained or otherwise associated with an online service associated with the retail store. Personalization facility 104 may accordingly access the user profile by way of the online service.

As used herein, an “online service” associated with a retail store may refer to any web-based business, website, application, and/or web-based service provided by or otherwise associated with the retail store. For example, the retail store may be associated with a wireless network service provider (e.g., VERIZON WIRELESS). In this case, an online service associated with the retail store may include an online shopping service provided by the same wireless network service provider. In some examples, the online service may be provided by an entity other than an entity that owns or operates the retail store. For example, assuming again that the retail store is associated with a wireless network service provider (e.g., VERIZON WIRELESS), the online service may include an online shopping service provided by an entity (e.g., AMAZON.COM) that is different than the wireless network service provider.

In some examples, the user profile associated with the user includes data representative of one or more personal traits and/or attributes of the user. For example, the user profile may include data representative of the user's name, age, gender, income level, profession, family status, nationality, lifestyle preferences, shopping preferences, etc. Additionally or alternatively, the user profile may include data representative of a subscription plan associated with the user (e.g., a wireless network service plan to which the user subscribes), data representative of one or more computing devices owned by or otherwise associated with the user, data representative of a purchase history of the user, data representative of an online browsing history of the user, data representative of a television viewing history of the user, and/or any other data that may be used to personalize an in-store and/or online shopping experience for the user.

Personalization facility 104 may identify a computing device associated with the user in any suitable manner. For example, if the user profile indicates that only a single mobile phone is associated with the user, personalization facility 104 may automatically identify the mobile phone as the computing device associated with the user profile.

Additionally or alternatively, personalization facility 104 may identify a computing device associated with the user by identifying a computing device associated with a user profile of the user. For example, personalization facility 104 may determine that a plurality of computing devices are associated with the user profile of the user. In this case, personalization facility 104 may identify the computing device associated with the user by presenting a plurality of graphical objects representative of the plurality of computing devices within an interface accessible by the user and detecting a selection by the user of one of the graphical objects.

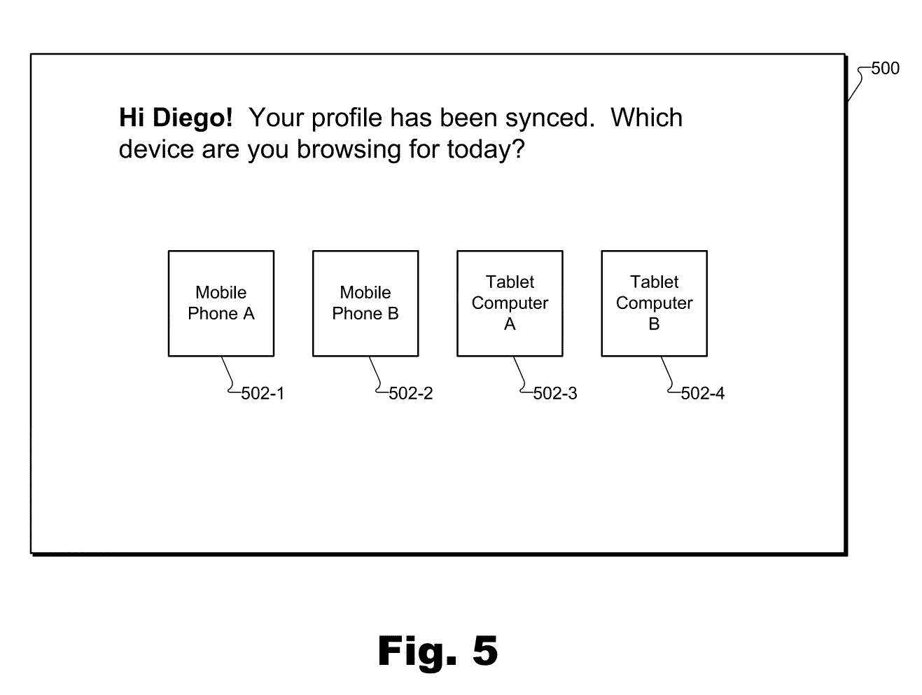

To illustrate, FIG. 5 shows an exemplary interface 500 that may be presented by way of a display accessible by the user and that may be used to facilitate selection of a particular computing device for which the user is shopping for accessories. Interface 500 may be presented by way of a physical display associated with the retail store and/or by way of a display screen associated with a mobile device carried by the user while the user is located within the geographic vicinity of the retail store.

As shown, personalization facility 104 has determined that four computing devices (e.g., a mobile phone labeled “mobile phone A”, a mobile phone labeled “mobile phone B”, a tablet computer labeled “tablet computer A”, and a tablet computer labeled “tablet computer B”) are associated with the user profile of the user. Personalization facility 104 may accordingly present graphical objects 502-1 through 502-4 (collectively “graphical objects 502”) each representative of one of the computing devices associated with the user within interface 500. The user may select a particular graphical object 502 in order to indicate that the user is interested in shopping for accessories associated with the computing device represented by the selected graphical object 502. For example, the user may select graphical object 502-1 in order to indicate that the user is interested in shopping for accessories related to the mobile phone labeled “mobile phone A”.

Additionally or alternatively, personalization facility 104 may identify the computing device associated with the user by determining that the user is going to purchase a particular computing device from the retail store and designating the particular computing device as the computing device associated with the user. For example, the user may decide to purchase a mobile device from the retail store. Input representative of this decision may be provided to personalization facility 104, which may then identify the mobile device as being associated with the user. In this manner, personalization facility 104 may provide a personalized in-store shopping experience for the user in accordance with the mobile phone (e.g., by presenting content associated with accessories compatible with the mobile phone).

Personalization facility 104 may provide a personalized in-store shopping experience for the user in accordance with the user's user profile and the identified computing device while the user is located within the geographic vicinity of the retail store. This may be performed in any suitable manner. For example, personalization facility 104 may use the user profile and the identified computing device to select and present personalized content for the user by way of a display located within the geographic vicinity of the retail store. In some examples, the display by which the personalized content is presented is not associated with the user. In other words, the personalized content is presented by way of a display associated with the retail store (e.g., a display operated by retail store personnel) and not by way of a display screen associated with a mobile device carried by the user while the user is located within the geographic vicinity of the retail store.

Personalization facility 104 may present the personalized content for the user by way of the display in any suitable manner. Various examples of presenting personalized content based on the user profile and the identified computing device will now be described.

In some examples, personalization facility 104 may present personalized content for the user by way of the display by identifying one or more accessories available in the retail store that are compatible with the identified computing device and presenting content associated with the identified one or more accessories by way of the display.

As an example, a user may enter a retail store that provides accessories for mobile phones. Detection facility 102 may detect that the user is located within the retail store in any of the ways described herein. Personalization facility 104 may access a user profile associated with the user and determine that the user is named Diego and that the user uses a particular type of mobile phone. Personalization facility 104 may accordingly identify accessories compatible with the particular type of mobile phone used by the user and present content associated with the identified accessories by way of a display located within the retail store (e.g., by way of a display positioned near a display case that houses accessories).

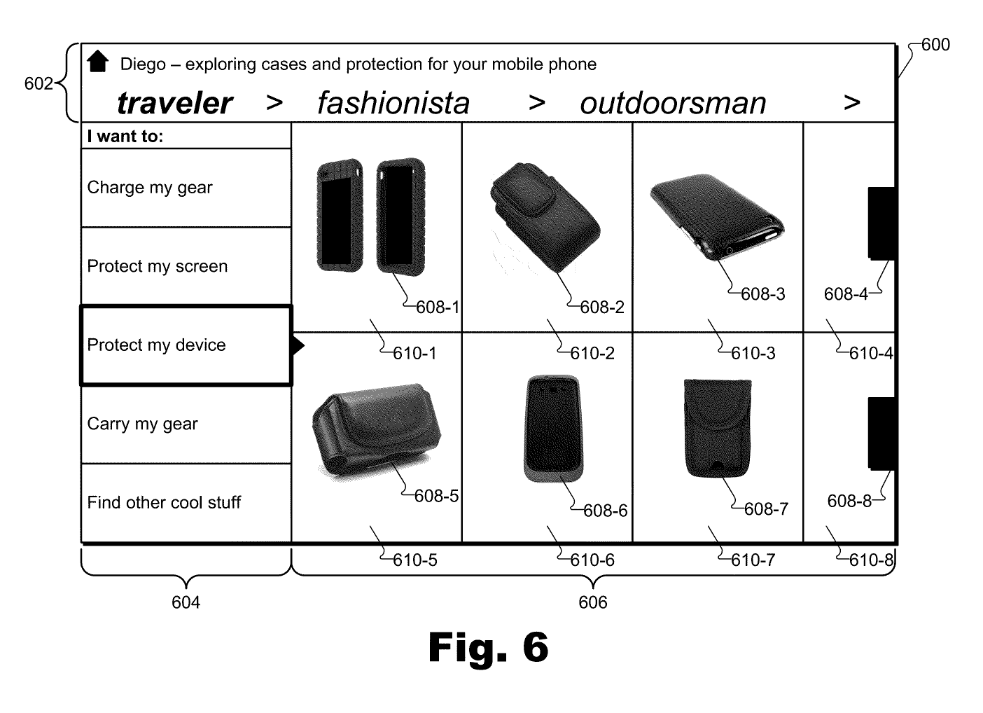

To illustrate, FIG. 6 shows an exemplary interface 600 that may be presented to the user by way of the display and that may include content associated with accessories that have been identified as being compatible with the mobile phone used by the user. As will be described below, the user may interact with interface 600 to browse through and access information (e.g., reviews, technical specifications, etc.) and options (e.g., purchasing options) associated with the identified accessories.

As shown, the content included in interface 600 may be organized within a header pane 602, a category pane 604, and an accessory pane 606. It will be recognized that the content may alternatively be organized within interface 600 in any other manner as may serve a particular implementation.

As shown, header pane 602 may display the name of the user and provide context within which the user is browsing. For example, header pane 602 identifies the user as “Diego” and indicates that the user is currently exploring cases and protection for his mobile phone.

Category pane 604 may include a list of selectable accessory categories into which the various accessories are organized. Each accessory category may include one or more accessories identified as being compatible with the user's mobile phone. For example, FIG. 6 shows that a “charge my gear” category, a “protect my screen” category, a “protect my device” category, a “carry my gear” category, and a “find other cool stuff” category are included within category pane 604. Other categories may be included within category pane 604 as may serve a particular implementation.

A user may select one of the accessory categories included within category pane 604 in order to view one or more accessories associated with selected accessory category. For example, FIG. 6 shows that the user has selected the “protect my device” category to view carrying cases and other types of protective devices compatible with his mobile phone.

As shown, personalization facility 104 may present selectable graphical objects 608 (e.g., graphical objects 608-1 through 608-8) representative of accessories identified as being compatible with the user's mobile phone within accessory pane 606. In the particular example of FIG. 6, the accessories represented by graphical objects 608 are included within the “protect my device” category. As shown, each graphical object 608 may include an image of its corresponding accessory and may be displayed within a cell 610 (e.g., cells 610-1 through 610-8). Additionally or alternatively, each graphical object 608 may include text (e.g., a name and/or price of the accessory) and/or any other type of content as may serve a particular implementation.

In some examples, the display that presents interface 600 may be associated with (e.g., located within) a particular section of the retail store where a subset of the accessories available in the retail store are physically displayed. In these examples, the accessories represented by graphical objects 608 may be included in the subset. For example, interface 600 may be presented by way of display located relatively near a display case that houses a particular type of accessory (e.g., carrying cases). Personalization facility 104 may accordingly select accessories for inclusion in interface 600 from the accessories that are housed in the display case.

In some examples, the user may browse through the various graphical objects 608 displayed within accessory pane 606. This may be performed in any suitable manner. For example, the user may perform one or more touch gestures (e.g., swipe gestures) with respect to display upon which interface 600 is presented in order to scroll through the various graphical objects 608 displayed within accessory pane 606.

In some examples, the user may select a particular graphical object 608 displayed within accessory pane 606 to access additional information and/or options associated with the accessory represented by the selected graphical object 608. For example, the user may select graphical object 608-1 by touching graphical object 608-1, the cell 610-1 in which graphical object 608-1 is displayed, and/or in any other suitable manner. Personalization facility 104 may detect the selection of graphical object 608-1 and, in response, present one or more options associated with the accessory represented by graphical object 608-1 within interface 600.

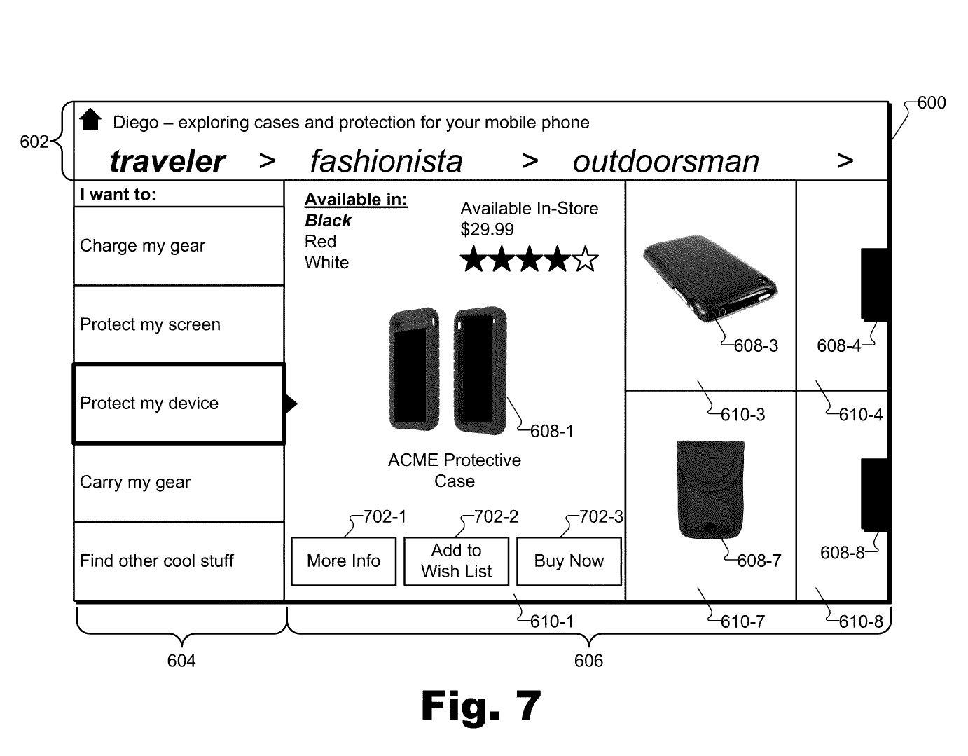

To illustrate, FIG. 7 shows interface 600 after graphical object 608-1 is selected by the user. As shown, the cell 610-1 in which graphical object 608-1 is displayed has been expanded to include additional details not shown in the view shown in FIG. 6. For example, a name of the accessory represented by graphical object 608-1, color availability of the accessory, pricing information associated with the accessory, and ratings information associated with the accessory are now displayed in cell 610-1.

FIG. 7 also shows that various selectable options 702 (e.g., options 702-1 through 702-3) associated with the accessory represented by graphical object 608-1 may be presented within interface 600 in response to the selection of graphical object 608-1. For example, a user may select option 702-1 to view additional information associated with the accessory, option 702-2 to add the accessory to a wish list associated with the user, and/or option 702-3 to purchase the accessory. Each of these options will now be described in more detail.

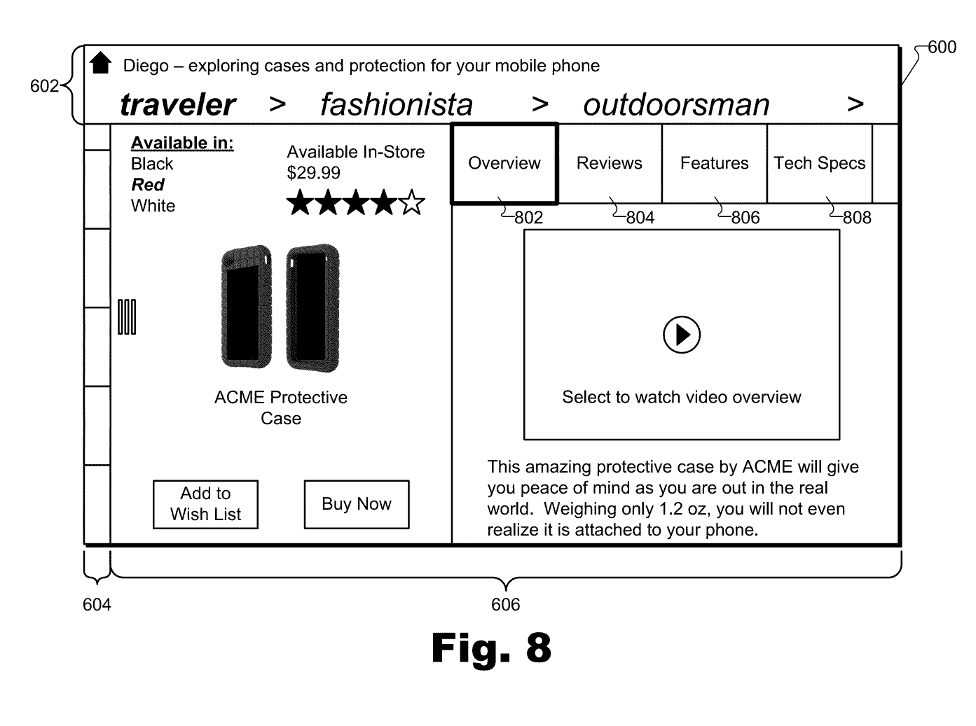

FIG. 8 shows interface 600 after the “more info” option 702-1 shown in FIG. 7 is selected by the user. As shown, in response to the selection of option 702-1, category pane 604 may be minimized and accessory pane 606 may be expanded to display additional information associated with the accessory represented by graphical object 608-1. As shown, the additional information may include an overview 802 of the accessory, reviews 804 associated with the accessory, information descriptive of various features 806 of the accessory, and technical specifications 808 of the accessory. Additional or alternative information associated with the accessory may be presented within interface 600 in response to user selection of option 702-1 as may serve a particular implementation.

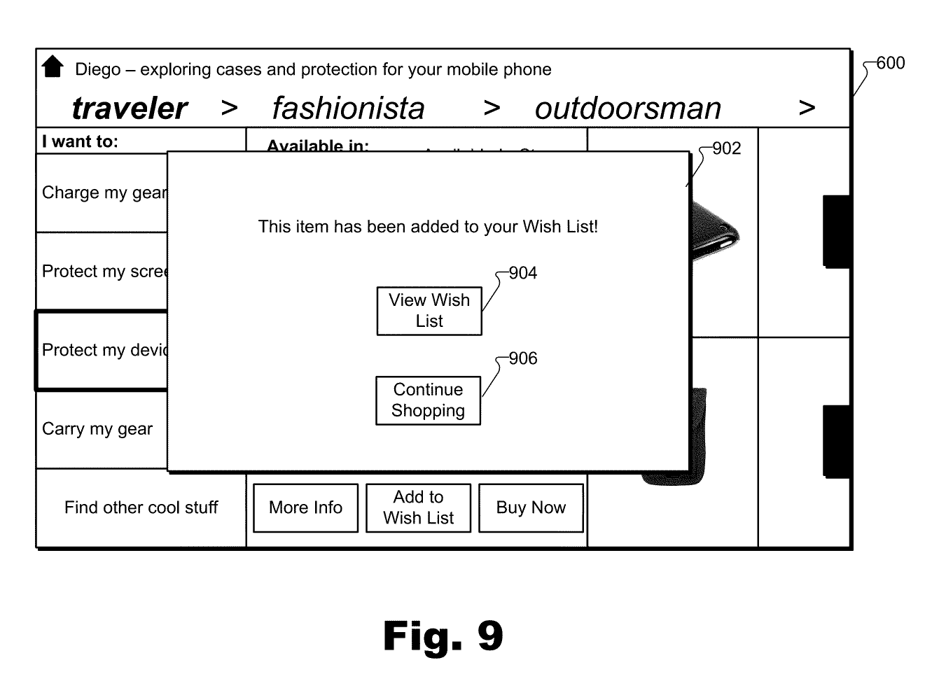

FIG. 9 shows interface 600 after the “add to wish list” option 702-2 shown in FIG. 7 is selected by the user. Personalization facility 104 may detect a selection of option 702-2, and, in response, add the accessory to a wish list associated with the user. In some examples, the wish list is an online wish list associated with the user and provided by an online service associated with the retail store. By adding the accessory to the wish list, the user may access information and/or options associated with the accessory after the user leaves the retail store by accessing the online service (e.g., by accessing a website associated with the retail store).

As shown in FIG. 9, in response to the selection by the user of option 702-2, personalization facility 104 may present a notification 902 within interface 600 that the accessory has been added to the user's wish list. Notification 902 may include a “view wish list” option 904, which may be selected by the user to view the user's wish list, and a “continue shopping” option 906, which may be selected by the user to close notification 902 and continue shopping by interacting with interface 600. Notification 902 may include one or more other options as may serve a particular implementation.

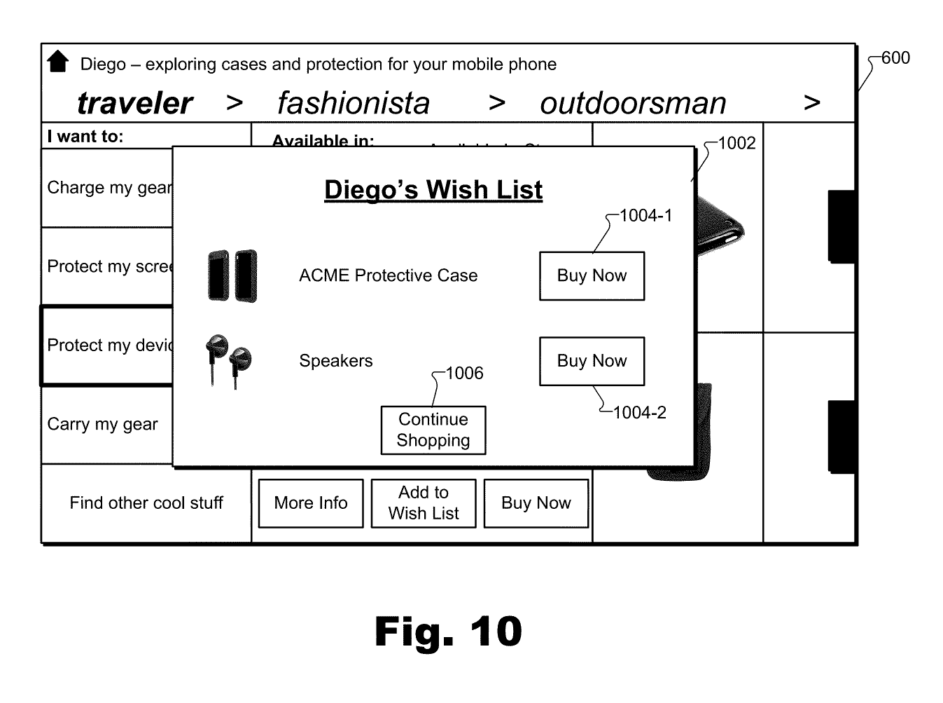

FIG. 10 shows interface 600 after the “view wish list” option 904 included within notification 902 is selected by the user. As shown, presentation facility 104 may present a graphical representation 1002 of the user's wish list in response to the user selection of option 904. In addition to items added by the user while the user is in the retail store, the wish list may include one or more items previously added to the wish list by the user before the user entered the retail store. For example, the wish list may include items (e.g., the speakers shown in FIG. 10) added to the wish list while the user is shopping online at a website or other online service provided by or otherwise associated with the retail store.

As shown in FIG. 10, “buy now” options 1004-1 and 1004-2 may be presented within the graphical representation 1002 of the user's wish list. The user may select one or more of these options 1004-1 and 1004-2 to purchase one or more of the items included in the user's wish list. Alternatively, the user may select a “continue shopping” option 1006 to close graphical representation 1002 and continue shopping by interacting with interface 600.

Returning to FIG. 7, the user may select the “buy now” option 702-3 to purchase the accessory represented by graphical object 608-1. Personalization facility 104 may detect the selection of option 702-3 and, in response, present a checkout interface by way of a computing device (e.g., a tablet computer) utilized by a representative (e.g., a sales associate) of the retail store. The checkout interface may be configured to facilitate a checkout transaction between the representative and the user in which the user purchases the accessory.

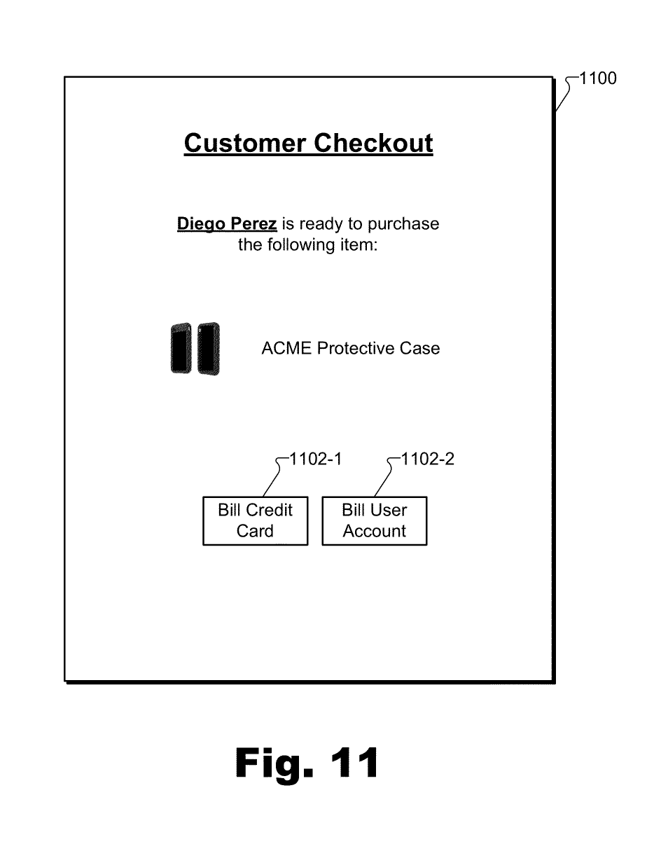

To illustrate, FIG. 11 shows an exemplary checkout interface 1100 that may be presented by way of a computing device utilized by a representative of the retail store in response to a user selection of option 702-3 shown in FIG. 7. As shown, checkout interface 1100 may identify the user and the accessory that the user has decided to purchase. Checkout interface 1100 may additionally or alternatively include one or more transaction options associated with the accessory. For example, the representative may select option 1102-1 to bill a purchase price of the accessory to a credit card associated with the user. Alternatively, the representative may select option 1102-2 to automatically bill the purchase price of the accessory to a credit account associated with the user profile of the user. By presenting checkout interface 1100, personalization facility 104 may obviate the need for the user to stand in a line to purchase the accessory.

In some examples, personalization facility 104 may present personalized content for the user by way of the display by presenting a list of a plurality of lifestyle categories by way of the display, detecting a selection by the user of a lifestyle category included in the plurality of lifestyle categories, identifying one or more accessories available in the retail store that are associated with the lifestyle category and that are compatible with the identified computing device, and presenting content associated with the identified one or more accessories by way of the display.

To illustrate, reference is again made to FIG. 6. As shown, a list of lifestyle categories (e.g., the lifestyle categories labeled “traveler”, “fashionista”, and “outdoorsman”) is displayed within header pane 602. Each lifestyle category may have a different set of accessories associated therewith. For example, the lifestyle category labeled “traveler” may include accessories that may be desirable to people who travel frequently. In contrast, the lifestyle category labeled “fashionista” may include accessories that may be desirable by people interested in making a fashion statement with their accessories. In some examples, the user may select one of the lifestyle categories (e.g., by touching a particular lifestyle category displayed within header pane 602) to filter the accessories represented in accessory pane 606 so that only those accessories associated with the selected lifestyle category are displayed within accessory pane 606.

In some examples, a default lifestyle category may be automatically selected by personalization facility 104 based on one or more attributes of the user as defined in the user's user profile. For example, the user profile of a user may indicate that the user is an eighteen-year-old female who often accesses fashion blogs online. Personalization facility 104 may accordingly select the “fashionista” lifestyle category for this user so that she is automatically presented with accessories that are potentially of interest to her.

In some examples, personalization facility 104 may track how the user interacts with personalized content presented by way of a display located within the retail store and use the tracked information to provide a personalized online shopping experience for the user. For example, with reference to FIG. 6, the user may select graphical object 608-1 to access additional information and/or options associated with the accessory represented by graphical object 608-1. This action may indicate that the user is interested in the accessory. Personalization facility 104 may accordingly detect that the user has selected graphical object 608-1 and provide a personalized online shopping experience for the user in accordance with the selection by the user of graphical object 608-1. For example, personalization facility 104 may present online content associated with the accessory represented by graphical object 608-1 to the user while the user is accessing an online service associated with the retail store after the user has left the retail store.

To illustrate, graphical object 608-1 may be representative of a protective case for a particular type of mobile phone, as described above. In response to the user selecting graphical object 608-1, personalization facility 104 may select and present online content associated with the protective case (e.g., one or more recommended items, promotional content associated with the protective case if the user did not end up purchasing the protective case while in the retail store, etc.) to the user when the user subsequently accesses a website associated with the retail store.

Personalization facility 104 may likewise provide a personalized in-store shopping experience for a user based on one or more online actions taken by the user prior to the user entering the retail store. For example, personalization facility 104 may determine that a user accesses an item provided by a retail store by way of an online service associated with the retail store (e.g., by determining that the user has selected a link associated with the item, viewed the item, or otherwise accessed the item). Detection facility 102 may detect that the user is located within a geographic vicinity of the retail store at a time subsequent to the user accessing the item by way of the online service. In response, personalization facility 104 may provide a personalized in-store shopping experience for the user in accordance with the accessed item while the user is located within the geographic vicinity of the retail store.

To illustrate, a user may access an item (e.g., an accessory) provided by the retail store by way of an online service (e.g., a website or an app) associated with the retail store (e.g., by clicking on a link associated with the item). The user may subsequently visit the retail store. While the user is in the retail store, personalization facility 104 may present the user with content associated with the item and/or any other related item by way of a display within the retail store.

Personalization facility 104 may additionally or alternatively present personalized content for the user by way of a display located in the retail store by using the user profile to identify computing devices and/or any other items provided by the retail store that the user may be interested in purchasing. Personalization facility 104 may then present content associated with the identified computing devices and/or other items by way of the display.

For example, a user may enter a retail store with the intent to purchase a mobile phone. Personalization facility 104 may access the user profile of the user and identify, based on the user profile, one or more mobile phones that the user may be interested in purchasing. Content descriptive of the one or more mobile phones may then be presented by way of the display. The user may interact with the content and select a particular mobile phone included in the one or more mobile phones for purchase.

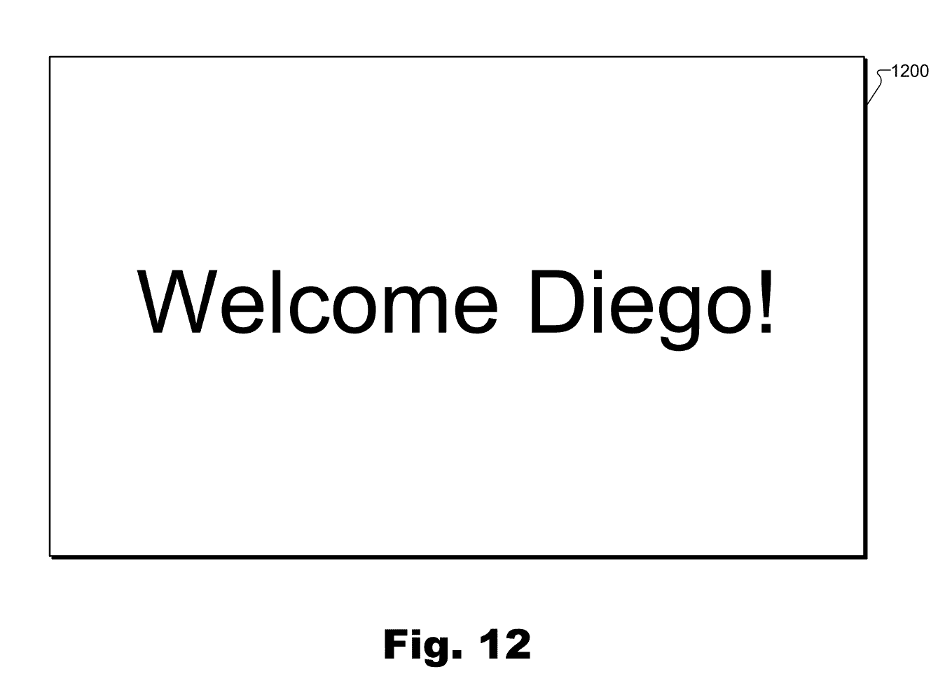

Personalization facility 104 may additionally or alternatively present personalized content for the user by way of the display by using the user profile to identify a name of the user and presenting the name of the user by way of the display. For example, referring again to the example described above in which the user named Diego enters the retail store, personalization facility 104 may access a user profile associated with the user and determine that the user is named Diego. In response, as shown in FIG. 12, personalization facility 104 may present a welcome message that includes the user's name (e.g., “Welcome Diego!”) within an interface 1200 that is presented by way of a display located within the retail store (e.g., a relatively large display that is viewable by multiple people within the retail store). The user's name may additionally or alternatively be presented within a display located within the geographic vicinity of the retail store in any other manner (e.g., by presenting the name of the user in interface 600, as shown in FIG. 6). Other information associated with the user as specified in the user's user profile may additionally or alternatively be presented by way of a display located within the geographic vicinity of the retail store as may serve a particular implementation.

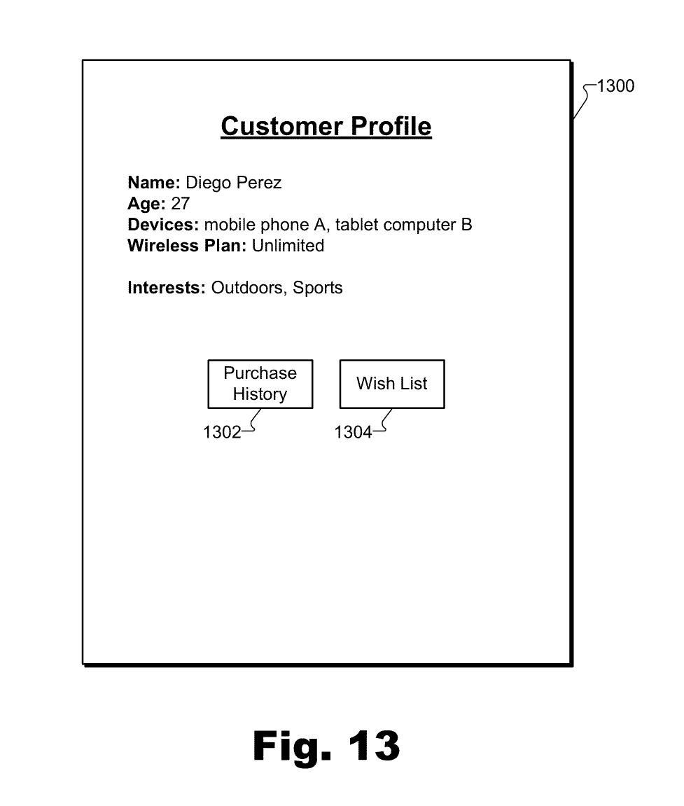

Personalization facility 104 may additionally or alternatively provide a personalized in-store shopping experience for the user by presenting content associated with the user by way of a computing device (e.g., a tablet computer) associated with (e.g., used by) a representative of the retail store. For example, FIG. 13 shows an exemplary interface 1300 that may be presented by way of a computing device used by a representative of the retail store in response to personalization facility 104 accessing a user profile of a user who has entered into the retail store. As shown, interface 1300 may include information about the user, such as the user's name, age, associated computing devices, wireless plan, and interests. Interface 1300 may also include one or more selectable options associated with the user. For example, the representative may select option 1302 to access a purchase history of the user and/or option 1304 to access a wish list associated with the user. This information may allow the representative to more effectively serve the user while the user is in the retail store.

In some examples, personalization facility 104 may provide a personalized in-store shopping experience for the user by detecting that the user is located within a geographic vicinity of a display located within the geographic vicinity of the retail store and, in response, present personalized content for the user by way of the display. In this manner, personalized content may be dynamically presented to the user by way of different displays located through the retail store as the user moves from location to location within the retail store.

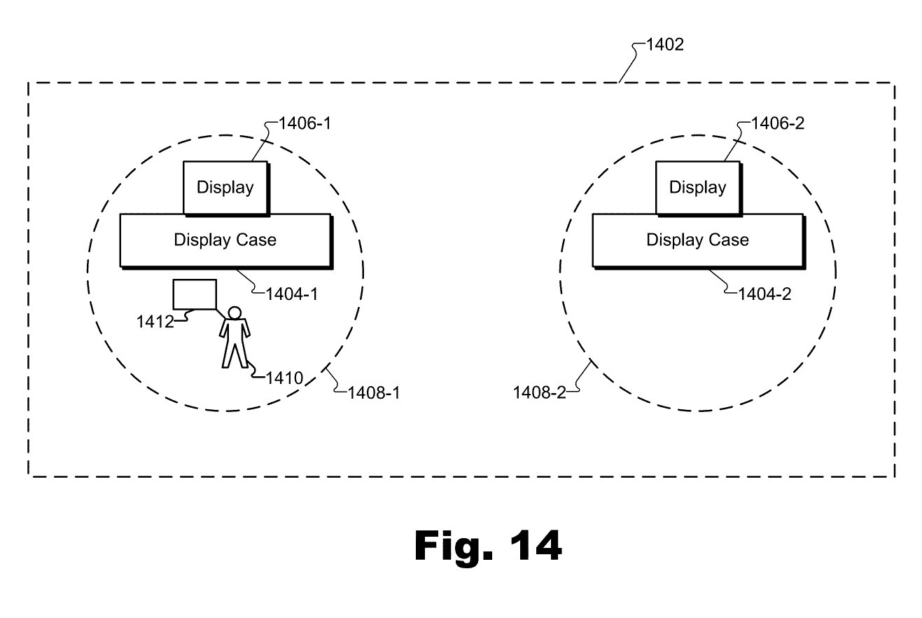

To illustrate, FIG. 14 shows an exemplary geographic vicinity 1402 of a retail store. As shown, display cases 1404-1 and 1404-2 (collectively “display cases 1404”) may be located within the geographic vicinity 1402 of the retail store. Each display case 1404 may house a group of accessories. As also shown in FIG. 14, a display 1406 may be associated with (e.g., located in close proximity to) each display case 1404 (e.g., display 1406-1 is associated with display case 1404-1, and display 1406-2 is associated with display case 1404-2). Each display 1406 may be configured to present content associated with the accessories housed within each display's associated display case 1404. Each display 1406 may also have a geographic vicinity 1408 associated therewith. For example, geographic vicinity 1408-1 is associated with display 1406-1, and geographic vicinity 1408-2 is associated with display 1406-2. Geographic vicinities 1408 may be defined in any suitable manner as may serve a particular implementation.

As shown, a user 1410 carrying a mobile device 1412 may initially be located within the geographic vicinity 1408-1 of display 1406-1. Personalization facility 104 may detect that the user 1410 is located within geographic vicinity 1408-1 of display 1406-1 and, in response, present personalized content for the user 1410 by way of display 1406-1. The personalized content may be associated, for example, with the accessories housed within display case 1404-1.

Personalization facility 104 may detect that the user 1410 is located within geographic vicinity 1408-1 of display 1406-1 in any suitable manner. For example, personalization facility 104 may utilize any of the location tracking heuristics described above (e.g., GPS, NFC, etc.) with respect to detecting that the user is located in a geographic vicinity of a retail store to further detect that the user 1410 is located within geographic vicinity 1408-1 of display 1406-1.

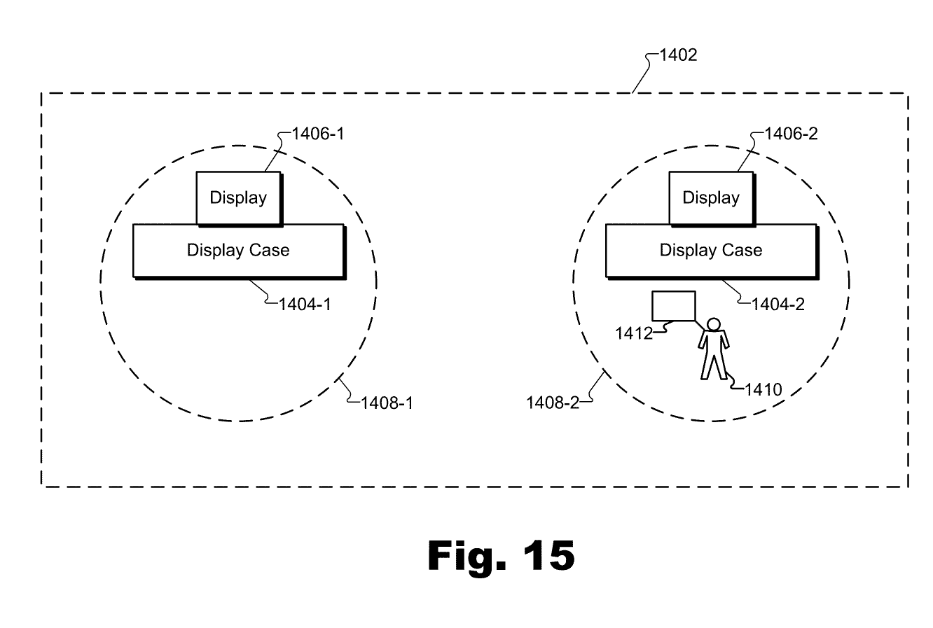

FIG. 15 shows that user 1410 has moved to a location that is within the geographic vicinity 1408-2 of display 1406-2 and not within the geographic vicinity 1408-1 of display 1406-1. Personalization facility 104 may detect this movement and, in response, cease providing the personalized content for the user 1410 by way of display 1406-1 and commence providing personalized content for the user 1410 by way of display 1406-2. The personalized content may be associated, for example, with the accessories housed within display case 1404-2.

As described above, the operations performed by system 100 may be performed in response to a user-initiated action while the user is located within a geographic vicinity of the retail store. For example, the operations performed by system 100 may be performed in response to a user proactively establishing a communication link between his or her mobile device and a computing device located within the geographic vicinity of the retail store. In some alternative examples, the operations performed by system 100 may be performed automatically when the user enters the geographic vicinity of the retail store. For example, system 100 may receive input provided by the user prior to the user being located within the geographic vicinity of the retail store (e.g., by way of one or more settings specified by the user while the user is accessing an online service associated with the retail store before the user enters the retail store). The input may be representative of a request to allow system 100 to automatically detect that the user is located within the geographic vicinity of the retail store when the user enters the geographic vicinity of the retail store, automatically access the user profile while the user is located within the geographic vicinity of the retail store, automatically identify the computing device associated with the user profile while the user is located within the geographic vicinity of the retail store, and automatically provide the personalized in-store shopping experience for the user while the user is located within the geographic vicinity of the retail store. System 100 may accordingly perform each of these operations automatically when the user enters the geographic vicinity of the retail store.

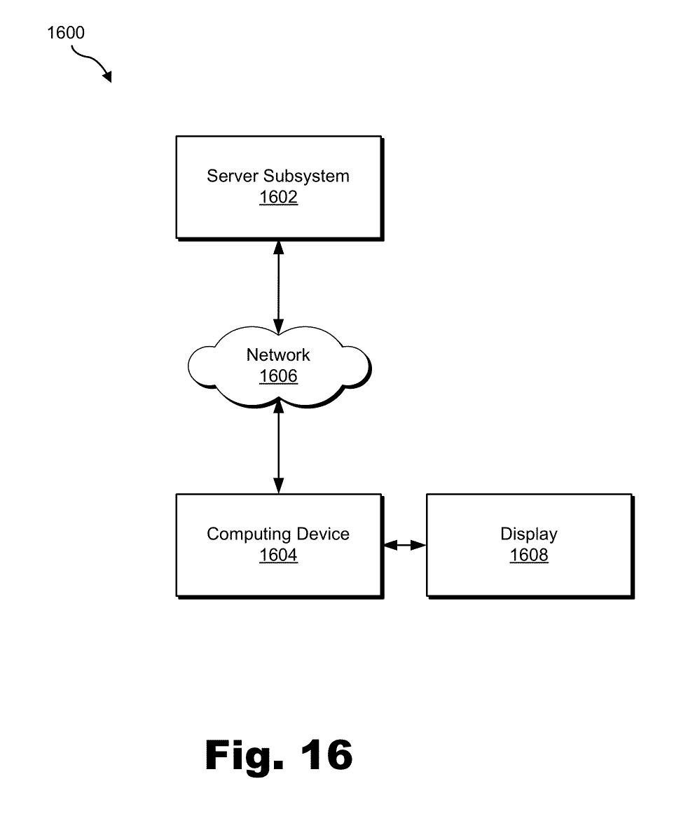

FIG. 16 illustrates an exemplary implementation 1600 of system 100 wherein a server subsystem 1602 is communicatively coupled to a computing device 1604 by way of a network 1606. Computing device 1604 is associated with (e.g., connected to) a display 1608. As will be described in more detail below, detection facility 102, personalization facility 104, and storage facility 106 may each be implemented by server subsystem 1602, computing device 1604, and/or display 1608.

Server subsystem 1602 may be associated with a service provider (e.g., an online service provider, a shopping personalization service provider, an Internet service provider, etc.) and/or any other entity. Server subsystem 1602 may be implemented by one or more computing devices as may serve a particular implementation.

Computing device 1604 may be implemented by any suitable combination of processing or computing devices. For example, computing device 1604 may be implemented by one or more personal computers, mobile devices (e.g., mobile phones and/or tablet computers), set-top box devices, personal-digital assistant devices, television devices, etc.

Display 1608 may be implemented by any of the displays described herein. For example, display 1608 may be implemented by a physical display, such as a display screen associated with a computing device, a television display, and/or any other physical display as may serve a particular implementation.

Computing device 1604 and display 1608 may be located within the geographic vicinity of a retail store. Server subsystem 1602 may be located remote from the geographic vicinity of the retail store. Server subsystem 1602 and computing device 1604 may accordingly communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

Server subsystem 1602 and computing device 1604 may communicate using any suitable network. For example, as shown in FIG. 16, server subsystem 1602 and computing device 1604 may be configured to communicate with each other by way of network 1606. Network 1606 may include one or more networks or types of networks capable of carrying communications and/or data signals between server subsystem 1602 and computing device 1604. For example, network 1606 may include, but is not limited to, a cable network, an optical fiber network, a hybrid fiber coax network, a wireless network (e.g., a Wi-Fi and/or mobile telephone network), a satellite network, a wireless broadcast network (e.g., a satellite media broadcasting network or terrestrial broadcasting network), a subscriber television network, a provider-specific network, the Internet, an intranet, a local area network, any other suitable network, and/or any combination or sub-combination of these networks.

In certain embodiments, system 100 may be implemented entirely by server subsystem 1602 or by computing device 1604 and display 1608. In other embodiments, components of system 100 may be distributed across server subsystem 1602, computing device 1604, and/or display 1608.

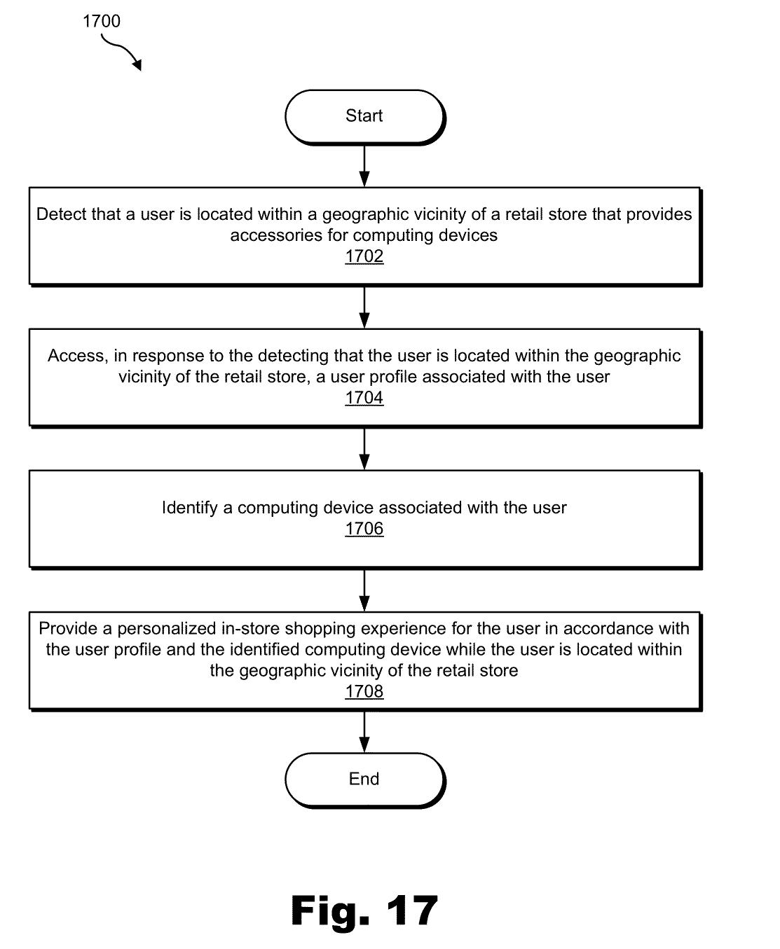

FIG. 17 illustrates an exemplary method 1700 of personalizing an in-store shopping experience for a user in a retail store. While FIG. 17 illustrates exemplary steps according to one embodiment, other embodiments may omit, add to, reorder, and/or modify any of the steps shown in FIG. 17. One or more of the steps shown in FIG. 17 may be performed by system 100 and/or any implementation thereof.

In step 1702, a shopping personalization system detects that a user is located within a geographic vicinity of a retail store that provides accessories for computing devices. Step 1702 may be performed in any of the ways described herein.

In step 1704, the shopping personalization system accesses, in response to the detecting that the user is located within the geographic vicinity of the retail store, a user profile associated with the user. Step 1704 may be performed in any of the ways described herein.

In step 1706, the shopping personalization system identifies a computing device associated with the user. Step 1706 may be performed in any of the ways described herein.

In step 1708, the shopping personalization system provides a personalized in-store shopping experience for the user in accordance with the user profile and the identified computing device while the user is located within the geographic vicinity of the retail store. Step 1708 may be performed in any of the ways described herein.

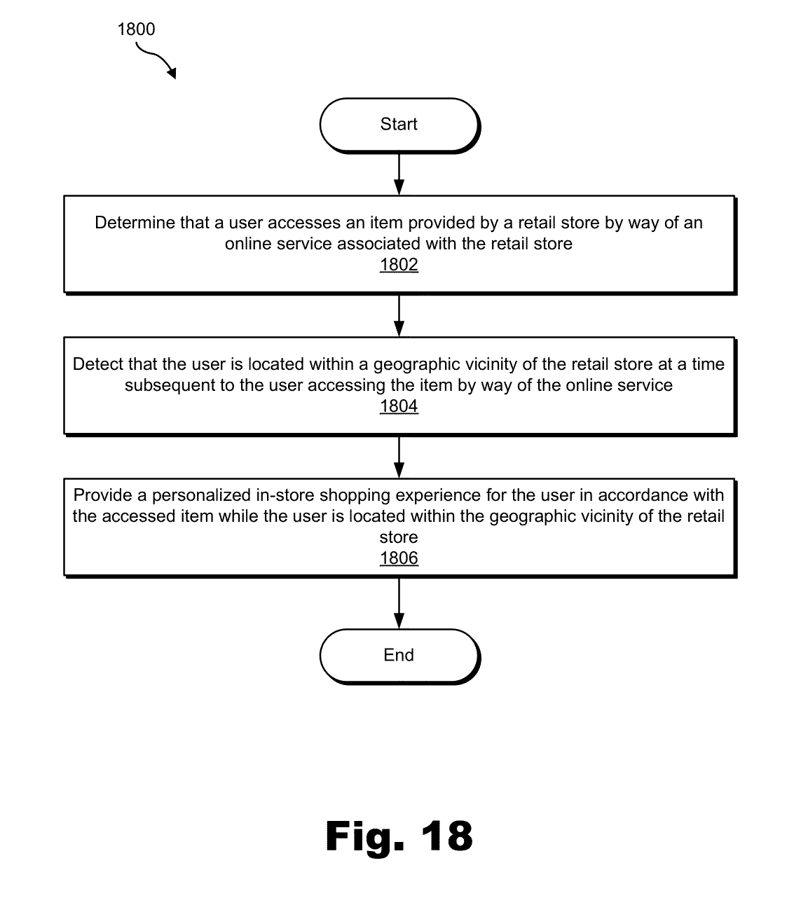

FIG. 18 illustrates another exemplary method 1800 of personalizing an in-store shopping experience for a user in a retail store. While FIG. 18 illustrates exemplary steps according to one embodiment, other embodiments may omit, add to, reorder, and/or modify any of the steps shown in FIG. 18. One or more of the steps shown in FIG. 18 may be performed by system 100 and/or any implementation thereof.

In step 1802, a shopping personalization system determines that a user accesses an item provided by a retail store by way of an online service associated with the retail store. Step 1802 may be performed in any of the ways described herein.

In step 1804, the shopping personalization system detects that the user is located within a geographic vicinity of the retail store at a time subsequent to the user accessing the item by way of the online service. Step 1804 may be performed in any of the ways described herein.

In step 1806, the shopping personalization system provides a personalized in-store shopping experience for the user in accordance with the accessed item while the user is located within the geographic vicinity of the retail store. Step 1806 may be performed in any of the ways described herein.

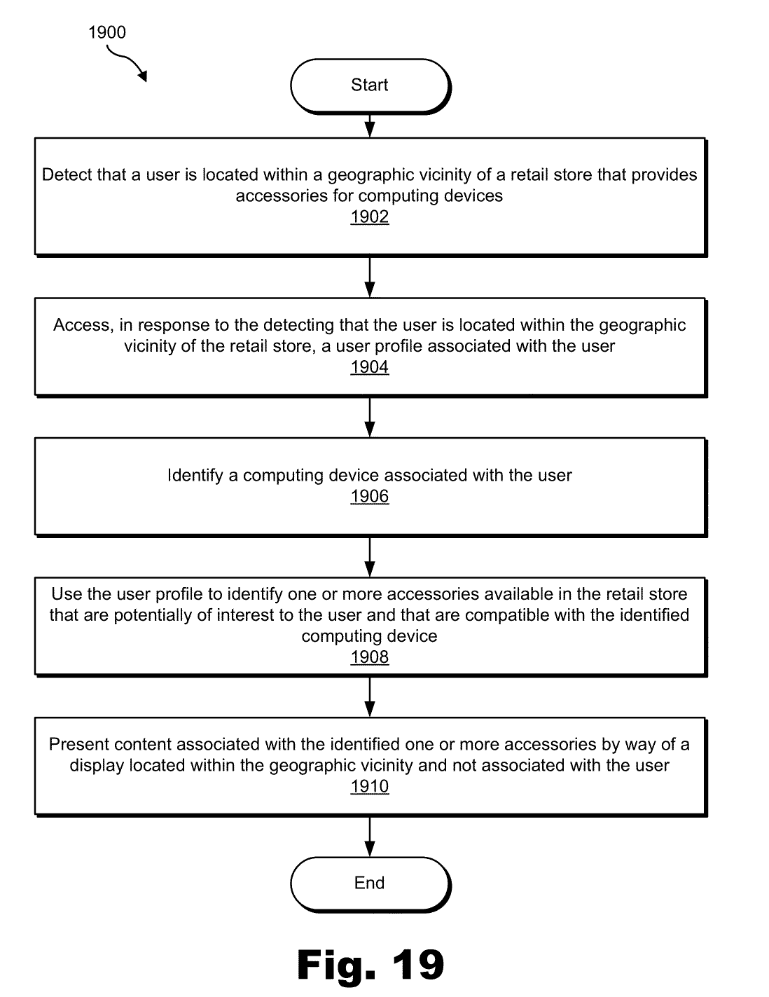

FIG. 19 illustrates another exemplary method 1900 of personalizing an in-store shopping experience for a user in a retail store. While FIG. 19 illustrates exemplary steps according to one embodiment, other embodiments may omit, add to, reorder, and/or modify any of the steps shown in FIG. 19. One or more of the steps shown in FIG. 19 may be performed by system 100 and/or any implementation thereof.

In step 1902, a shopping personalization system detects that a user is located within a geographic vicinity of a retail store that provides accessories for computing devices. Step 1902 may be performed in any of the ways described herein.

In step 1904, the shopping personalization system accesses, in response to the detecting that the user is located within the geographic vicinity of the retail store, a user profile associated with the user. Step 1904 may be performed in any of the ways described herein.

In step 1906, the shopping personalization system identifies a computing device associated with the user. Step 1906 may be performed in any of the ways described herein.

In step 1908, the shopping personalization system uses the user profile to identify one or more accessories available in the retail store that are potentially of interest to the user and that are compatible with the identified computing device. Step 1908 may be performed in any of the ways described herein.

In step 1910, the shopping personalization system presents content associated with the identified one or more accessories by way of a display located within the geographic vicinity and not associated with the user. Step 1910 may be performed in any of the ways described herein.

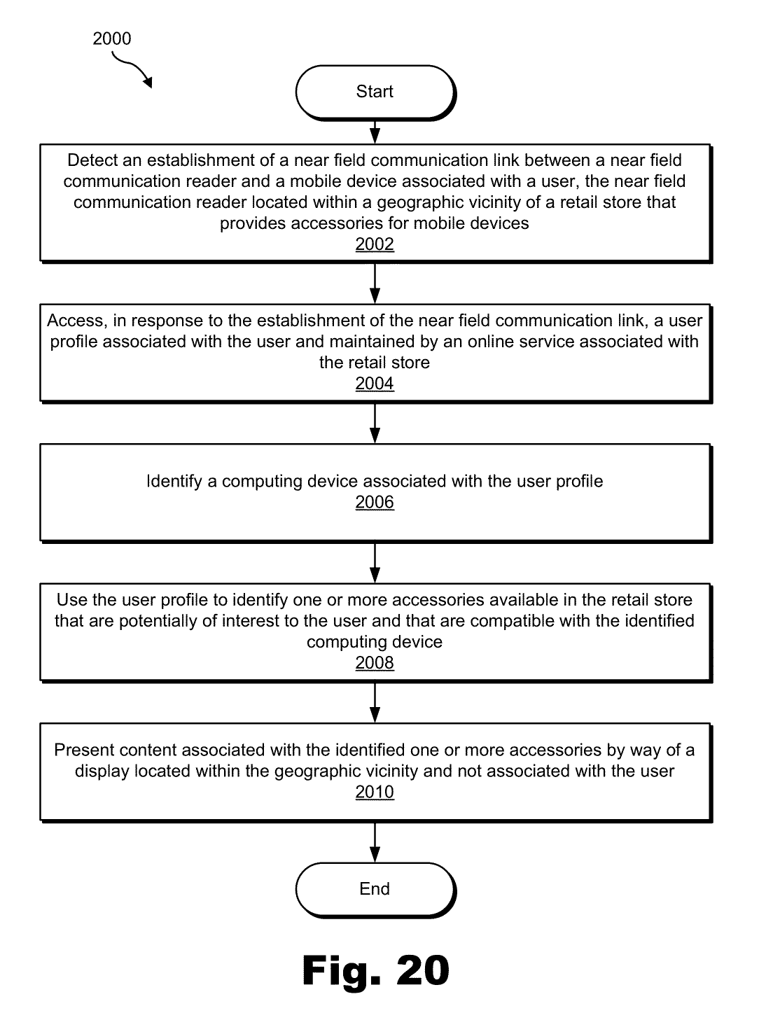

FIG. 20 illustrates another exemplary method 2000 of personalizing an in-store shopping experience for a user in a retail store. While FIG. 20 illustrates exemplary steps according to one embodiment, other embodiments may omit, add to, reorder, and/or modify any of the steps shown in FIG. 20. One or more of the steps shown in FIG. 20 may be performed by system 100 and/or any implementation thereof.

In step 2002, a shopping personalization system detects an establishment of a near field communication link between a near field communication reader and a mobile device associated with a user, the near field communication reader located within a geographic vicinity of a retail store that provides accessories for computing devices. Step 2002 may be performed in any of the ways described herein.

In step 2004, the shopping personalization system accesses, in response to the establishment of the near field communication link, a user profile associated with the user and maintained by an online service associated with the retail store. Step 2004 may be performed in any of the ways described herein.

In step 2006, the shopping personalization system identifies a computing device associated with the user profile. Step 2006 may be performed in any of the ways described herein.

In step 2008, the shopping personalization system uses the user profile to identify one or more accessories available in the retail store that are potentially of interest to the user and that are compatible with the identified computing device. Step 2008 may be performed in any of the ways described herein.

In step 2010, the shopping personalization system presents content associated with the identified one or more accessories by way of a display located within the geographic vicinity and not associated with the user. Step 2010 may be performed in any of the ways described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

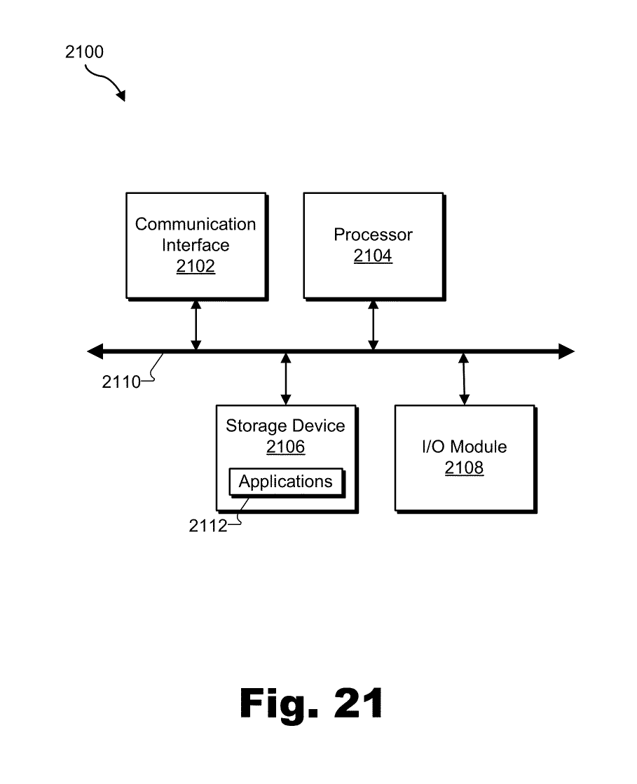

FIG. 21 illustrates an exemplary computing device 2100 that may be configured to perform one or more of the processes described herein. As shown in FIG. 21, computing device 2100 may include a communication interface 2102, a processor 2104, a storage device 2106, and an input/output (“I/O”) module 2108 communicatively connected via a communication infrastructure 2110. While an exemplary computing device 2100 is shown in FIG. 21, the components illustrated in FIG. 21 are not intended to be limiting. Additional or alternative components may be used in other embodiments. Components of computing device 2100 shown in FIG. 21 will now be described in additional detail.

Communication interface 2102 may be configured to communicate with one or more computing devices. Examples of communication interface 2102 include, without limitation, a wired network interface (such as a network interface card), a wireless network interface (such as a wireless network interface card), a modem, an audio/video connection, and any other suitable interface.

Processor 2104 generally represents any type or form of processing unit capable of processing data or interpreting, executing, and/or directing execution of one or more of the instructions, processes, and/or operations described herein. Processor 2104 may direct execution of operations in accordance with one or more applications 2112 or other computer-executable instructions such as may be stored in storage device 2106 or another computer-readable medium.

Storage device 2106 may include one or more data storage media, devices, or configurations and may employ any type, form, and combination of data storage media and/or device. For example, storage device 2106 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 2106. For example, data representative of one or more executable applications 2112 configured to direct processor 2104 to perform any of the operations described herein may be stored within storage device 2106. In some examples, data may be arranged in one or more databases residing within storage device 2106.

I/O module 2108 may be configured to receive user input and provide user output and may include any hardware, firmware, software, or combination thereof supportive of input and output capabilities. For example, I/O module 2108 may include hardware and/or software for capturing user input, including, but not limited to, a keyboard or keypad, a touch screen component (e.g., touch screen display), a receiver (e.g., an RF or infrared receiver), and/or one or more input buttons.

I/O module 2108 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 2108 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 2100. For example, one or more applications 2112 residing within storage device 2106 may be configured to direct processor 2104 to perform one or more processes or functions associated with detection facility 102 and/or personalization facility 104. Likewise, storage facility 106 may be implemented by or within storage device 2106.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A method comprising:
detecting, by a shopping personalization computing system, that a user is located within a geographic area of a retail store that is associated with a wireless network service provider and that provides accessories for computing devices, the detecting comprising detecting an establishment of a communication link between:
a mobile device carried by the user into the retail store, and
a detection device associated with and located within the geographic area of the retail store;
accessing, by the shopping personalization computing system in response to the detecting that the user is located within the geographic area of the retail store, a user profile associated with the user and maintained by the wireless network service provider;
identifying, by the shopping personalization computing system, a computing device linked to the user profile maintained by the wireless network service provider; and
personalizing, by the shopping personalization computing system, an electronic display of accessory options for the user in accordance with the user profile maintained by the wireless network service provider and the identified computing device while the user is located within the geographic area of the retail store.

2. The method of claim 1, wherein the personalizing the electronic display of accessory options for the user comprises presenting personalized content for the user by way of a display device located within the geographic area and not associated with the user.

3. The method of claim 2, wherein the presenting of the personalized content for the user by way of the display device comprises:
identifying one or more accessories available in the retail store that are compatible with the identified computing device; and
presenting content associated with the identified one or more accessories by way of the display device.

4. The method of claim 3, wherein the display device is associated with a section of the retail store where a subset of the accessories are physically displayed, and wherein the identifying of the one or more accessories that are compatible with the identified computing device comprises selecting the one or more accessories from the subset.

5. The method of claim 3, wherein the content associated with the identified one or more accessories comprises one or more graphical objects representative of the one or more accessories, and wherein the method further comprises:
detecting, by the shopping personalization computing system, a selection by the user of a graphical object included in the one or more graphical objects and representative of an accessory included in the one or more accessories; and
presenting, by the shopping personalization computing system by way of the display device and in response to the selection of the graphical object, one or more options associated with the accessory.

6. The method of claim 5, wherein the one or more options associated with the accessory comprise an option to purchase the accessory, and wherein the method further comprises:
detecting, by the shopping personalization computing system, a selection by the user of the option to purchase the accessory; and
presenting, by the shopping personalization computing system in response to the selection by the user of the option to purchase the accessory, a checkout interface by way of a checkout computing device utilized by a representative of the retail store, the checkout interface configured to facilitate a checkout transaction between the representative and the user in which the user purchases the accessory.

7. The method of claim 6, further comprising automatically billing, by the shopping personalization computing system, a purchase price of the accessory to a credit account associated with the user profile.

8. The method of claim 5, wherein the one or more options associated with the accessory comprise an option to add the accessory to a wish list associated with the user, and wherein the method further comprises:
detecting, by the shopping personalization computing system, a selection by the user of the option to add the accessory to the wish list; and
adding, by the shopping personalization computing system in response to the selection by the user of the option to add the accessory to the wish list, the accessory to an online wish list associated with the user and provided by an online service associated with the retail store.

9. The method of claim 3, wherein the content associated with the identified one or more accessories comprises one or more graphical objects representative of the one or more accessories, and wherein the method further comprises:
detecting, by the shopping personalization computing system, a selection by the user of a graphical object included in the one or more graphical objects and representative of an accessory included in the one or more accessories; and
personalizing, by the shopping personalization computing system, the electronic display of the accessory options for the user in accordance with the selection by the user of the graphical object representative of the accessory.

10. The method of claim 9, wherein the personalizing the electronic display of the accessory options comprises presenting online content associated with the accessory represented by the graphical object to the user while the user is accessing an online service associated with the retail store.

11. The method of claim 2, wherein the presenting of the personalized content for the user by way of the display device comprises:
presenting a list of a plurality of lifestyle categories by way of the display device;
detecting a selection by the user of a lifestyle category included in the plurality of lifestyle categories;
identifying one or more accessories available in the retail store that are associated with the lifestyle category and that are compatible with the identified computing device; and
presenting content associated with the identified one or more accessories by way of the display device.

12. The method of claim 2, wherein the presenting of the personalized content for the user by way of the display device comprises:
using the user profile to identify a name of the user; and
presenting the name of the user by way of the display device.

13. The method of claim 2, wherein the presenting of the personalized content for the user by way of the display device comprises:
using the user profile to identify one or more accessories that are potentially of interest to the user; and
presenting content associated with the identified one or more accessories by way of the display device.

14. The method of claim 1, wherein the personalizing the electronic display of accessory options for the user comprises:
detecting that the user is located within a geographic area of a display device located within the geographic area of the retail store; and
presenting, in response to the detecting that the user is located within the geographic area of the display device, personalized content for the user by way of the display device.

15. The method of claim 14, wherein the personalizing the electronic display of accessory options for the user further comprises:
detecting that the user moves to a location that is within a geographic area of an additional display device and not within the geographic area of the display device; and
in response to the user moving to the location that is within the geographic area of the additional display device and not within the geographic area of the display device,
ceasing to present the personalized content for the user by way of the display device, and
presenting additional personalized content for the user by way of the additional display device.

16. The method of claim 1, wherein the identified computing device linked to the user profile maintained by the wireless network service provider is the mobile device carried by the user into the retail store and used to detect the establishment of the communication link.

17. The method of claim 1, wherein the identified computing device linked to the user profile maintained by the wireless network service provider and the mobile device carried by the user into the retail store and used to detect the establishment of the communication link are different.

18. The method of claim 1, wherein the detection device located within the geographic area of the retail store comprises a near field communication reader, and wherein the detecting of the establishment of the communication link comprises detecting establishment of a near field communication link between the mobile device and the near field communication reader.

19. The method of claim 1, wherein the identifying of the computing device linked to the user profile maintained by the wireless network service provider comprises:
determining that a plurality of computing devices are associated with the user profile, each of the plurality of computing devices being linked to the user profile maintained by the wireless network service provider;
presenting a plurality of graphical objects representative of the plurality of computing devices within an interface accessible by the user; and
detecting a selection by the user of a graphical object included in the plurality of graphical objects and representative of the computing device.

20. The method of claim 1,
further comprising displaying a graphical prompt for the user to enable the shopping personalization computing system to identify the computing device at least in part by either:
holding the mobile device in a specified location to establish a near field communication link between the mobile device and the detection device; and
transmitting a short message service message to a specified telephone number.

21. The method of claim 1, further comprising:
receiving, by the shopping personalization computing system, input provided by the user prior to the user being located within the geographic area of the retail store, the input representative of a request to allow the shopping personalization computing system to automatically detect that the user is located within the geographic area of the retail store, automatically access the user profile while the user is located within the geographic area of the retail store, automatically identify the computing device linked to the user profile maintained by the wireless network service provider while the user is located within the geographic area of the retail store, and automatically personalize the electronic display of accessory options for the user while the user is located within the geographic area of the retail store;
wherein the detecting, accessing, identifying, and personalizing are automatically performed in accordance with the request.

22. The method of claim 1, embodied as computer-executable instructions on at least one non-transitory computer-readable medium.

23. A method comprising:
determining, by a shopping personalization computing system, that a user accesses, prior to the user entering a retail store, an item provided by the retail store by way of an online service associated with the retail store;
detecting, by the shopping personalization computing system, that the user entered a geographic area of the retail store at a time subsequent to the user accessing the item by way of the online service; and
personalizing, by the shopping personalization computing system and while the user is located within the geographic area of the retail store, an electronic display of accessory options for the user in accordance with the item that the user accessed by way of the online service prior to entering the retail store.

24. The method of claim 23, wherein the personalizing the electronic display of accessory options comprises presenting content associated with the item for the user by way of a display device located within the geographic area and not associated with the user.

25. A system comprising:
a detection facility that detects that a user is located within a geographic area of a retail store that is associated with a wireless network service provider and that provides accessories for computing devices, the detecting comprising detecting an establishment of a communication link between:
a mobile device carried by the user into the retail store, and
a detection device associated with and located within the geographic area of the retail store; and
a personalization facility communicatively coupled to the detection facility and that
accesses, in response to the detection that the user is located within the geographic area of the retail store, a user profile associated with the user and maintained by the wireless network service provider,
identifies a computing device linked to the user profile maintained by the wireless network service provider, and
personalizes an electronic display of accessory options for the user in accordance with the user profile maintained by the wireless network service provider and the identified computing device while the user is located within the geographic area of the retail store.
